(19) United States
(12) Patent Application Publication
(10) Pub. No.: US 2015/0286399 A1
(43) Pub. Date: Oct. 8, 2015

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Masao Akuzawa, Sagamihara-shi (JP)

(21) Appl. No.: 14/677,491

(22) Filed: Apr. 2, 2015

(30) Foreign Application Priority Data
Apr. 4, 2014 (JP) 2014-078215

(51) Int. Cl. G06F 3/0488; G06F 3/041

(52) U.S. Cl. CPC G06F 3/04883; G06F 3/041

(57) ABSTRACT

An information processing apparatus includes a detection unit configured to detect an operation position and an operation type of an operation performed in a display screen, a control unit configured to display a magnified display region, which is obtained by magnifying a predetermined display region containing the operation position, based on the operation position and the operation type detected by the detection unit, and a notification unit configured to notify an application, which provides screen information to the display screen, of the operation position and the operation type detected in the display screen including the displayed magnified display region.

### BACKGROUND OF THE INVENTION

1. Field of the Invention

The present disclosure generally relates to information processing and, more particularly, to an information processing apparatus, control method, storage medium, and to a screen display control technique for an information processing apparatus equipped with a touch panel capable of detecting a plurality of indicated points.

2. Description of the Related Art

Information processing apparatuses that are equipped with a touch panel and are able to be operated by the user touching a display screen of the touch panel with a finger or a pen are in widespread use. The touch panel is an input device that outputs coordinates corresponding to the position that the user's finger or pen has contacted. The information processing apparatus is able to detect operations performed on the touch panel, such as touch-down, touch-on, move, touch-up, touch-off, and multi-touch, to perform a predetermined action.

The term “touch-down” means that the finger or pen has touched the touch panel. The term “touch-on” means that the finger or pen is in contact with the touch panel. The term “move” means that the finger or pen is moving while being in contact with the touch panel. The term “touch-up” means that the finger or pen, which has touched the touch panel, is separated from the touch panel. The term “touch-off” means that none is in contact with the touch panel. The term “multi-touch” means that the fingers or the like have simultaneously touched a plurality of points.

Furthermore, the information processing apparatus can detect other operations, such as pinch-in and pinch-out. The term “pinch-in” means such an operation that the user simultaneously uses two fingers, the index finger and thumb, to touch the touch panel and shortens the distance between two points in such a way as to pinch the surface of the touch panel. The term “pinch-out” means such an operation that the user lengthens the distance between two points.

Such an information processing apparatus can further display, on a display screen of the touch panel, various pieces of visible information, such as character strings, graphics, images, and operation buttons. However, if a number of pieces of visible information are displayed on the display screen, character strings, etc., displayed thereon become very small in size, so that the content thereof may become illegible. Therefore, the user may not reach the desired visible information.

There is also an issue specific to touch panels. For example, when the user presses a certain region on the touch panel with the finger, the finger used to press the region may overlap the region, thus hiding character strings, etc., displayed in the region. Furthermore, when the user presses a small region, it may become difficult to position the finger with respect to the desired region. Under these circumstances, in the case of conventional information processing apparatuses, the user may not perform an accurate operation on the touch panel.

To solve the above-mentioned issues, Japanese Patent Application Laid-Open No. 2012-178175 discusses a function called a “magnifying glass”. The magnifying glass is a function of magnifying and displaying, at a predetermined magnification, the content of a predetermined region of the display screen on another window, which is separately provided on the display screen and is smaller in size than the display screen.

Furthermore, Japanese Patent Application Laid-Open No. 2001-242981 discusses a function of, when an operation is performed on a magnified and displayed region, converting the coordinates of the region into the coordinates of an original region and issuing a notice about the coordinates of the original region, and, when an operation is performed on other than the magnified and displayed region, closing the magnifying glass.

For example, most business machines and mobile terminals allow the touch panel to display a button image region that can be selected to provide a predetermined function. Thus, the touch panel can be used as a selection screen or an operation screen for functions. Since the user can magnify and display a button image region, which the user intends to operate, with the magnifying glass, the magnifying glass has the advantage of improving legibility and visibility.

However, the advantage of the magnifying glass cannot be sufficiently utilized due to the following issues:

Even if the magnifying glass is displayed, the magnifying glass disappears at the time of operation of touch-up.

Since a portion magnified and displayed with the magnifying glass is an image, the portion does not respond to a user operation.

To terminate the magnifying glass, an exit operation is performed on other than the region of the magnifying glass. Therefore, eye movement is involved up to a position for selecting the exit operation.

### SUMMARY OF THE INVENTION

The present disclosure is directed to an information processing apparatus capable of improving visibility and operability for users to magnify screen information displayed on a touch panel.

According to an aspect of the present disclosure, an information processing apparatus includes a detection unit configured to detect an operation position and an operation type of an operation performed in a display screen, a control unit configured to display a magnified display region, which is obtained by magnifying a predetermined display region containing the operation position, based on the operation position and the operation type detected by the detection unit, and a notification unit configured to notify an application, which provides screen information to the display screen, of the operation position and the operation type detected in the display screen including the displayed magnified display region.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an information processing apparatus according to an exemplary embodiment of the present invention.

FIG. 2 is a block diagram illustrating a functional configuration of the information processing apparatus according to the exemplary embodiment.

FIG. 3 illustrates the concept of calculation used for displaying a magnifying glass.

FIG. 4 illustrates the concept of operation of touch-down on the magnifying glass.

FIG. 5 is a flowchart illustrating a procedure of processing performed when input information is received.

FIG. 6 is a flowchart illustrating a procedure of processing for displaying a magnifying glass.

FIGS. 7A, 7B, and 7C illustrate operations of displaying and moving the magnifying glass.

FIG. 8 is a flowchart illustrating a procedure of processing performed at the time of operation of touch-down on the magnifying glass.

FIG. 9 is a flowchart illustrating a procedure of processing for hiding the magnifying glass.

FIG. 10 is a flowchart illustrating a procedure of processing for determining hiding (non-display) of the magnifying glass.

FIGS. 11A, 11B, 11C, and 11D illustrate display screens displayed at the time of notification of touch-down.

### DESCRIPTION OF THE EMBODIMENTS

Various exemplary embodiments, features, and aspects of the disclosure will be described in detail below with reference to the drawings. In the following exemplary embodiments, an example of an information processing apparatus having a display screen the size of which is small as compared with the stationary type apparatus, such as a mobile terminal or a business machine, is described. The information processing apparatus is able to display, on the display screen, a magnified display region, which is a region corresponding to the above-mentioned magnifying glass. Thus, in the context of the present specification, the magnified display region is referred to as a “magnifying glass”.

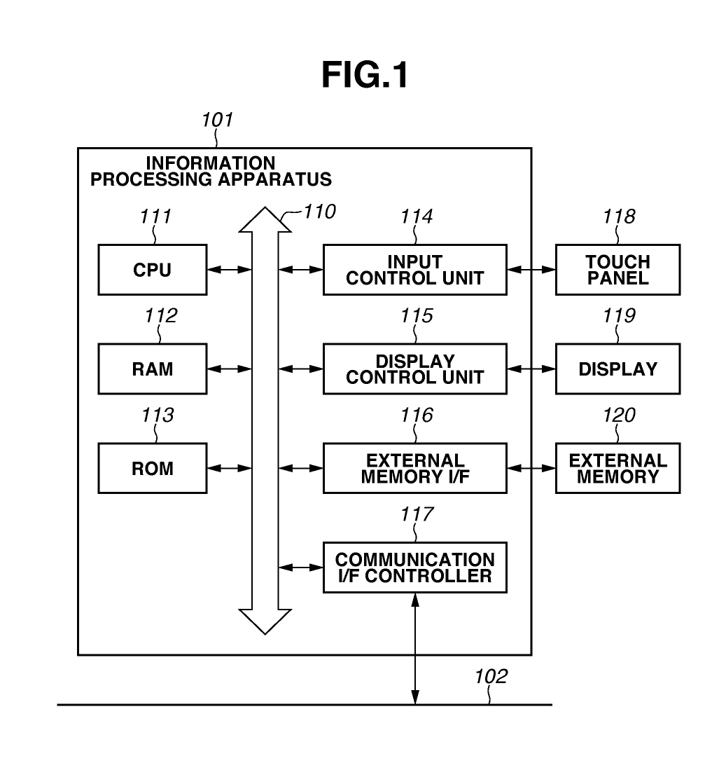

FIG. 1 is a block diagram illustrating a hardware configuration of an information processing apparatus 101 according to an exemplary embodiment of the present invention. The information processing apparatus 101 includes a central processing unit (CPU) 111, a random access memory (RAM) 112, and a read-only memory (ROM) 113, which are connected to a system bus 110. The information processing apparatus 101 further includes an input control unit 114, a display control unit 115, an external memory interface (I/F) 116, and a communication I/F controller 117, which are also connected to the system bus 110. These units 111 to 117 can exchange data between each other via the system bus 110. As used herein, the term “unit” generally refers to any combination of software, firmware, hardware, or other component, such as circuitry, that is used to effectuate a purpose.

The CPU 111 controls operations of the information processing apparatus 101 by executing computer programs. The CPU 111 further implements functions of the information processing apparatus 101, the configuration of which is described below. The RAM 112, which is a volatile memory, is used as a temporary storage region, such as a main memory or a work memory, for the CPU 111. The ROM 113 is a non-volatile memory. The ROM 113 stores data, such as image data, and various computer programs, based on which the CPU 111 operates, in respective predetermined regions. The image data is data used to generate an image serving as screen information to be displayed on a display 119.

A touch panel 118, a keyboard (not illustrated), and a mouse (not illustrated), which are input devices, are connected to the input control unit 114. The input control unit 114 generates input information indicating a user's operation position and a user's operation type received by an input device, and notifies the CPU 111 of the input information.

The display 119, which is a display device, is connected to the display control unit 115. The display control unit 115 causes the display 119 to display a graphical user interface (GUI) screen, which constitutes a GUI, based on a display control signal supplied from the CPU 111.

In the present exemplary embodiment, the touch panel 118 and the display 119 are integrated as a unit. More specifically, the touch panel 118 is configured to have such a light transmittance as not to hinder displaying by the display 119, and is mounted on an upper layer of the display surface of the display 119. This configuration enables the input coordinates on the touch panel 118 and the display coordinates on the display 119 to be associated with each other in a one-to-one relationship. Therefore, such a GUI as if the user is able to directly operate the display screen of the display 119 can be formed.

In addition, the touch panel 118 may be of the resistive film type, the electrostatic capacitance type, the surface acoustic wave type, the infrared ray type, the electromagnetic induction type, the image recognition type, or the photo-sensor type.

An external memory 120 is connected to the external memory I/F 116. The external memory 120 is, for example, a hard disk, a compact disc read-only memory (CD-ROM), a digital versatile disc (DVD), or a memory card. The external memory I/F 116 performs reading of data from the mounted external memory 120 and writing of data to the external memory 120 under the control of the CPU 111.

The communication I/F control unit 117 performs various communications with a network 102, such as a local area network (LAN), the Internet, a wired communication, and a wireless communication.

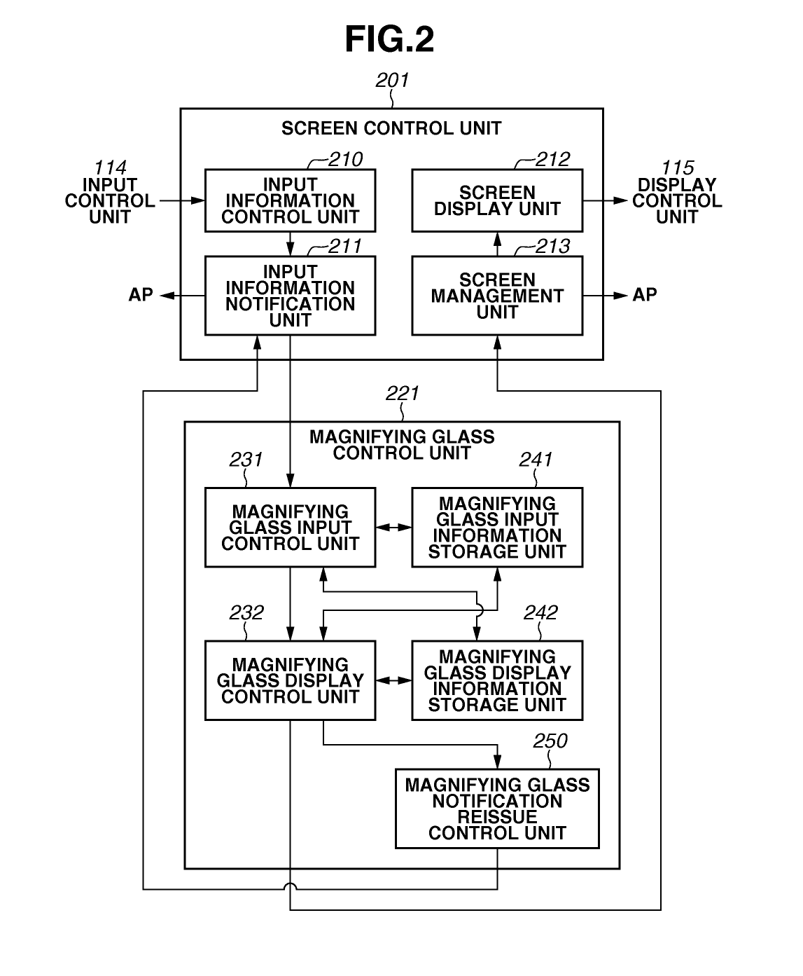

FIG. 2 is a block diagram illustrating a functional configuration of the information processing apparatus 101. The information processing apparatus 101 allows the CPU 111 to execute computer programs to establish functions of a screen control unit 201 and a magnifying glass control unit 221 as illustrated in FIG. 2.

The screen control unit 201 includes detailed functions of an input information control unit 210, an input information notification unit 211, a screen display unit 212, and a screen management unit 213. The magnifying glass control unit 221 includes detailed functions of a magnifying glass input control unit 231, a magnifying glass display control unit 232, a magnifying glass input information storage unit 241, a magnifying glass display information storage unit 242, and a magnifying glass notification reissue control unit 250.

The input information control unit 210 operates as a detection unit configured to detect a display state of the touch panel 118 and an operation position and an operation type of an operation performed by the user on the display screen of the touch panel 118 (the display 119). More specifically, the input information control unit 210 converts the operation position of an operation performed on the touch panel 118 into logical data that is able to be handled by the information processing apparatus 101, i.e., an x coordinate, a y coordinate, and changed values thereof. Furthermore, the input information control unit 210 detects operation types, such as the above-mentioned touch-down, touch-on, move, touch-up, and touch-off, by comparing the operation position and a changed value thereof with a predetermined condition.

The term “predetermined condition” means, for example, an operation pattern for discriminating characteristics of an operation. A change in time is also included in the predetermined condition. In other words, a state in which no operation is performed within a constant period is also one of operation types. Furthermore, movement information (movement direction, movement amount, and movement speed) of the finger or pen moving on the surface of the touch panel 118 is also one of operation types. Therefore, the input information control unit 210 is also able to detect the movement direction during move. In that case, the input information control unit 210 detects the movement direction for each of a vertical component and a horizontal component on the touch panel 118 based on a change in coordinates of the touch position.

Furthermore, the input information control unit 210 is able to simultaneously detect positions (coordinates) of touch-on and move. For example, the input information control unit 210 is able to detect an operation of moving the fingers from the state of touch-on of two points in such a way as to shorten or lengthen the distance information (for example, an interval) between the two points with respect to the direction of a line segment connecting the positions of the two points. Such an operation is called “pinch”. The input information control unit 210 determines, as pinch, a state in which each of or one of the two points has moved, and detects the coordinates of the middle point of a line segment connecting the two points and the distance information between the two points.

The input information control unit 210 notifies the input information notification unit 211 of input information indicating the detected operation position and operation type.

The input information notification unit 211 notifies one or more pieces of application software (hereinafter referred to as “AP”) operating on the information processing apparatus 101 of the input information of which the input information control unit 210 has notified the input information notification unit 211. This AP is used to provide screen information to the display screen. In this instance, the input information notification unit 211 may notify all of the APs of the input information, or may notify a specific AP of the input information. Alternatively, the input information notification unit 211 may notify only an AP that has issued a demand for receiving the notification.

The image display unit 212 outputs information of the display screen to the display 119 via the display control unit 115 in response to a request from the screen management unit 213.

The screen management unit 213 stores screen information of one or more APs. Furthermore, when receiving a request for switching screens, the screen management unit 213 shifts the designated screen to the foreground. Moreover, when a screen lying at the foreground has been hidden based on a management structure for screens, the screen management unit 213 shifts the appropriate screen, normally, an immediately preceding screen, to the foreground. For example, the screen management unit 213 can display a magnifying glass, which is described below, at the foreground, or can shift an immediately preceding screen to the foreground when the magnifying glass is hidden. In addition, the screen management unit 213 notifies an AP of a request for re-drawing a screen, which is likely to occur due to the execution of processing associated with a switching request for screens, and causes the AP to update the screen. The screen management unit 213 makes a request for displaying the screen to the screen display unit 212.

Furthermore, the screen management unit 213 notifies an AP of a request for re-drawing a screen, which is likely to occur due to the above-described screen switching processing, and causes the AP to update the screen. Moreover, the screen management unit 213 has a function to make a screen display request to the screen display unit 212. In addition, the screen management unit 213 has a function to manage input processing and a result of operation of an AP and to issue a notice of a result of specific input processing. For example, when receiving a request for a result of touch-down on an AP, the screen management unit 213 sends a response indicating the occurrence of screen transition if the transition of screens has been performed, and sends a response indicating the non-occurrence of screen transition if the transition of screens has not been performed. Furthermore, the screen management unit 213 receives a notification of power-saving shift of the information processing apparatus 101, converts the notification into input information, and requests the input information notification unit 211 to notify an AP of the power-saving shift information. The power-saving shift is an example of an operating state of the information processing apparatus 101.

The magnifying glass control unit 221 acts as a control unit configured to perform control over displaying, non-displaying (hiding), and changing of the magnifying glass in conjunction with the screen control unit 201. More specifically, the magnifying glass control unit 221 controls displaying, non-displaying (hiding), and changing of the magnifying glass on the touch panel 118 (the display 119) according to the operation position and the operation type detected by the input information control unit 210. The magnifying glass control unit 221 further controls notification of input information to an AP.

The magnifying glass input control unit 231 stores the input information received from the input information notification unit 211, as information indicating the visible state of the current display screen, into the magnifying glass input information storage unit 241. Furthermore, the magnifying glass input control unit 231 performs the following operations according to the operation position and the operation type indicated by the input information:

The magnifying glass input control unit 231 specifies a display region containing the operation position, in other words, a region serving as a magnification source.

The magnifying glass input control unit 231 calculates the magnitude of the magnifying glass (the size of a magnified display region).

The magnifying glass input control unit 231 calculates a region in which to display the magnifying glass. In this instance, the magnifying glass input control unit 231 performs association with a display region of the magnification source in such a way as to prevent the display region of the magnification source from being hidden by the magnifying glass or to prevent the region on which the magnifying glass is displayed from making it unclear which portion is the magnification source. The association is performed using an image display connecting the region on which the magnifying glass is displayed and the display region serving as a magnification source.

The magnifying glass input control unit 231 stores information of the calculated region into the magnifying glass display information storage unit 242.

The magnifying glass input control unit 231 issues, to the magnifying glass display control unit 232, notifications including a request for displaying or re-displaying the magnifying glass.

The magnifying glass display control unit 232 performs the following control operations according to the operation position and the operation type indicated by the input information:

The magnifying glass display control unit 232 changes a magnification ratio of screen information to be displayed on the magnifying glass.

The magnifying glass display control unit 232 requests the screen management unit 213 to update a screen used to display the magnifying glass.

The magnifying glass display control unit 232 compares the operation type detected by the input information control unit 210 with a predetermined condition for displaying the magnifying glass (hereinafter referred to as a “display condition”), and determines whether the operation type satisfies the display condition.

The magnifying glass display control unit 232 compares the operation type detected by the input information control unit 210 with a predetermined condition for hiding (not displaying) the magnifying glass (hereinafter referred to as a “hiding condition”), and determines whether the operation type satisfies the hiding condition.

The magnifying glass display control unit 232 receives the settings of the display condition and the hiding condition and stores the received display condition and hiding condition into the magnifying glass display information storage unit 242.

When “always-on display mode” is set “enabled”, the magnifying glass display control unit 232 causes the magnifying glass to be always displayed irrespective of the detected operation position and operation type as long as the AP is running on the information processing apparatus 101. When “always-on display mode” is set “disabled”, the magnifying glass display control unit 232 causes the magnifying glass to be hidden (not to be displayed) if the hiding condition is satisfied.

Each of the display condition and the hiding condition is one of conditions for performing display control over the magnifying glass. The display condition is satisfied if, for example, any one of the following operations is performed:

The detected operation type is a long press (touch-on continuing for a predetermined time or more). Thus, if the detected operation type is an operation in which the same operation continues for a predetermined time (a long press), it is determined that the display condition is satisfied.

The detected operation type is a double tap (touch-on being detected twice within a predetermined time).

A specific input key is pressed in the information processing apparatus 101 irrespective of the detected operation type.

The hiding condition is satisfied if, for example, any one of the following operations is performed or if any one of the following states of the information processing apparatus 101 is detected:

A specified time has elapsed from a specific operation on the display screen. For example, the detected operation type is touch-up, and the specified time has elapsed after touch-up.

The screen transition to a screen different from the display screen is detected.

The operating state of the information processing apparatus 101 is a predetermined state, for example, a power-saving state.

A specific input key is pressed in the information processing apparatus 101.

The latest input information is stored in the magnifying glass input information storage unit 241. For example, when the user “touches on” a certain position (coordinates x and y) on the touch panel 118, information indicating x, y, and touch-on is stored in the magnifying glass input information storage unit 241.

The magnifying glass display information storage unit 242 stores the following information:

Magnification ratio of the magnifying glass.

Information indicating the magnitude of the magnifying glass itself.

Information indicating a state as to whether the magnifying glass is output (visible state).

Information about the coordinates and magnitude of the magnifying glass and a region at which a press is detected. More specifically, the initial values of information about the magnification ratio and the magnitude of the magnifying glass itself may be fixed values, values input by the user via the touch panel 118, or values designated by the AP. In other words, these pieces of information are not limited to the specific ones described in the present exemplary embodiment.

Set display condition and hiding condition of the magnifying glass.

When receiving a request for a real touch-down notification from the magnifying glass display control unit 232, the magnifying glass notification reissue control unit 250 requests the input information notification unit 211 to reissue a touch-down notification to an AP serving as the magnification target source. Such a request is received in a case where the function for such a notification is previously set and a touch-down operation on the magnifying glass or on an area outside the magnifying glass is detected during displaying of the magnifying glass.

With respect to a “touch-down” operation performed within the magnifying glass, the magnifying glass notification reissue control unit 250 converts the operation position (input coordinates), included in the input information, into the coordinates of a display region obtained before being magnified. Then, the magnifying glass notification reissue control unit 250 generates input information indicating the operation position (input coordinates) set as the coordinates obtained after being converted and the operation type set as touch-down. The input information generated by the magnifying glass notification reissue control unit 250 in the above-described way is referred to, for convenience sake, as “converted input information” in the sense that it is different from the original input information. The magnifying glass notification reissue control unit 250 requests the input information notification unit 211 to reissue the notification to the AP, so as to enable reproducing an operation that the user has performed, based on the converted input information.

On the other hand, with respect to a “touch-down” operation performed on a region outside the magnifying glass, the magnifying glass notification reissue control unit 250 directly requests the input information notification unit 211 to reissue the notification to the AP.

Furthermore, in either case, with respect to input information requesting the reissue of the notification (converted input information), the magnifying glass input information storage unit 241 associates the converted input information with a reissue flag, which indicates that the notification is a reissue. If the input information is associated with the reissue flag, the magnifying glass notification reissue control unit 250 sets the reissue flag valid, thus preventing the same processing from being repeated on the received input information. On the other hand, if the input information is not associated with the reissue flag, the magnifying glass notification reissue control unit 250 sets the reissue flag invalid, thus enabling calculating a real touch-down position.

Moreover, on the occasion of the notification by the input information notification unit 211, the magnifying glass notification reissue control unit 250 requests the screen management unit 213 to receive a response indicating that the AP has performed processing on the screen information according to the operation type or that the AP has not performed any processing thereon. In addition, the magnifying glass notification reissue control unit 250 requests the magnifying glass display control unit 232 to cause screen information in which a result of the response is reflected to be displayed on the magnifying glass.

Furthermore, each of the magnifying glass input control unit 231, the magnifying glass display control unit 232, and the magnifying glass notification reissue control unit 250 is a function associated with the control over the magnifying glass, and these units may be implemented in the form of a single functional module. In the following description, in a case where it is not necessary to discriminate between these units as a subject that performs an operation, the operation is described as an operation of the magnifying glass control unit 221.

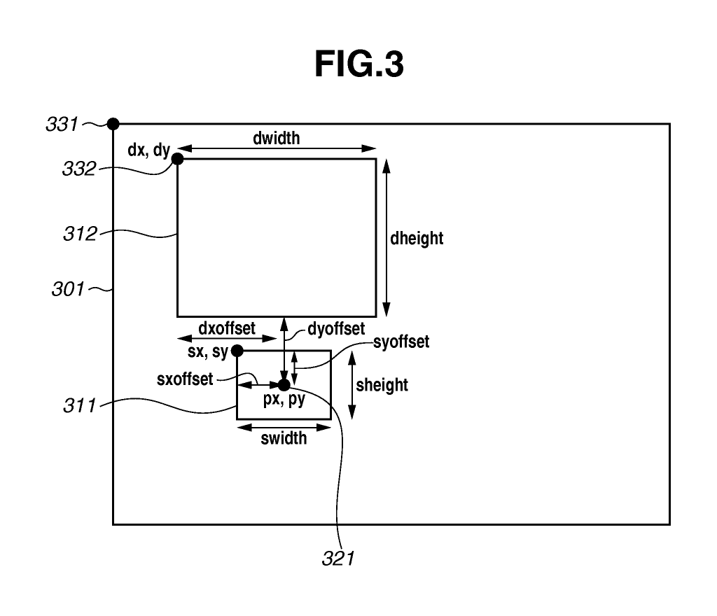

FIG. 3 illustrates the concept of calculation used for displaying the magnifying glass. A display screen 301 represents a region in which an image is displayed on the display 119. A display region 311 targeted for magnification represents a region of the magnification source (obtained before being magnified). A magnifying glass 312 is a region in which to magnify and display the display region 311.

Suppose that the x coordinate and y coordinate of an operation position (input point) 321 from the origin 331 of the display screen 301 are px and py, respectively, and the relative horizontal width and relative vertical width of the magnifying glass 312 from the display region 311 are dxoffset and dyoffset, respectively. Furthermore, suppose that the horizontal width and vertical width of the display region 311 are swidth and sheight, respectively. Suppose that the x coordinate and y coordinate of the starting point of the display region 311 are sx and sy, respectively, and the relative horizontal width and relative vertical width from the coordinates (px, py) to the coordinates (sx, sy) are sxoffset and syoffset, respectively. Suppose that the x coordinate and y coordinate of the starting point 322 of the magnifying glass 312 are dx and dy, respectively, and the horizontal width and vertical width of the magnifying glass 312 are dwidth and dheight, respectively. Suppose that the magnification ratio stored in the magnifying glass display information storage unit 242 is “r”. The magnification ratio “r” may be set to have different values for the respective x component and y component.

The magnifying glass display control unit 232 calculates sx and sy, which are information about the display region 311, as follows:

sx=px−sxoffset

sy=py−syoffset

Furthermore, the magnifying glass display control unit 232 calculates dx, dy, dwidth, and dheight, which are information about the magnifying glass 312, as follows:

dx=px−dxoffset

dy=py−dyoffset

dwidth=swidth×r

dheight=sheight×r

In addition, the values “r”, sxoffset, syoffset, swidth, sheight, dxoffset, and dyofffset may be fixed values, values input by the user via the touch panel 118, or values designated by the AP. In other words, these values are not limited to the ones described in the present exemplary embodiment.

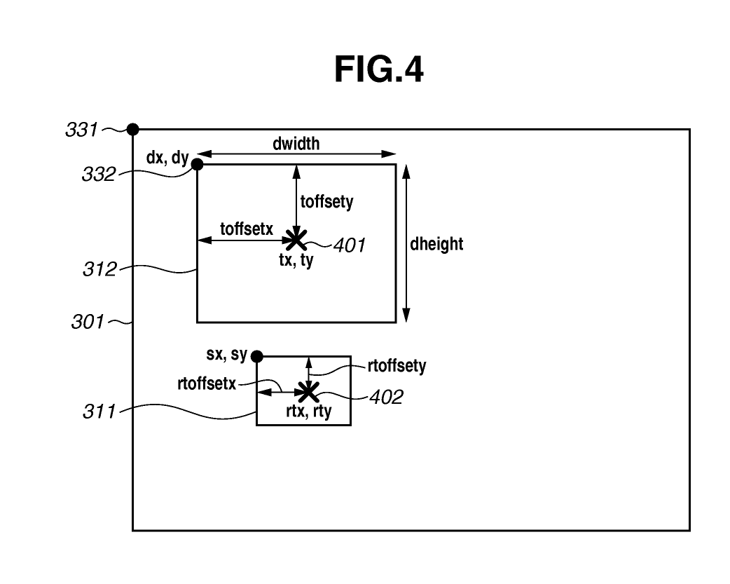

Next, the relationship between the magnifying glass and the display region at the time of a touch-down operation is described. FIG. 4 illustrates the concept of the above-described real touch-down. When an operation of touch-down is performed inside the magnifying glass 312 (when such an operation type is detected), the magnifying glass display control unit 232 is notified, from the input information notification unit 211, that the operation of touch-down has been performed and of an operation position of the touch-down operation (the coordinates of the input point). For example, suppose that the touch-down operation has been detected at an operation position 401 illustrated in FIG. 4. Suppose that the x component and y component of the operation position 401 are tx and ty, respectively. The components tx and ty are located at distances of toffsetx and toffsety from the starting point (dx, dy) of the magnifying glass 312.

The distances toffsetx and toffsety can be calculated as follows:

toffsetx=tx−dx

toffsety=ty−dy

The position (coordinates) 402 of the display region 311 corresponding to the operation position 401 is calculated as a position (coordinates) on the display screen 301, which is obtained by performing coordinate transformation on the operation position (tx, ty) based on the magnification ratio “r”. The operation position obtained by performing coordinate transformation is referred to as a “real touch-down position”. The x component rtx and y component rty are located at distances of rtoffsetx and rtoffsety from the coordinates (sx, sy), respectively.

The magnifying glass display control unit 232 calculates the real touch-down position 402 from the operation position 401 of touch-down as follows:

$$rtoffsetx = ( toffsetx ) / r$$

$$rtoffsety = ( toffsety ) / r$$

$$\begin{matrix}rtx = sx + rtoffsetx \\ = px - sxoffset + ( tx - dx ) / r\end{matrix}$$

$$\begin{matrix}rty = sy + rtoffsety \\ = py - syoffset + ( ty - dy ) / r\end{matrix}$$

The magnifying glass display control unit 232 determines that the touch-down position 401 is located inside the magnifying glass 312 if the following two conditional expressions are satisfied, and, otherwise, determines that the touch-down position 401 is located in an area outside the magnifying glass 312:

dx<tx<dx+dwidth

dy<ty<dy+dheight

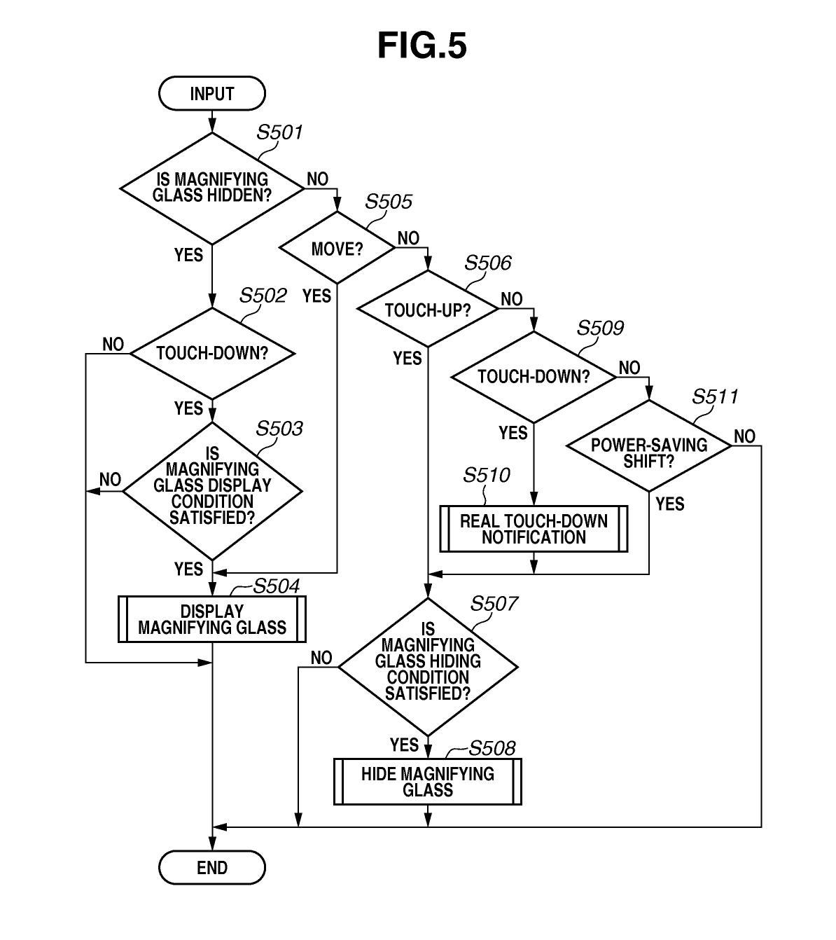

FIG. 5 is a flowchart illustrating a procedure of processing performed when the magnifying glass display control unit 232 has received the input information. In step S501, the magnifying glass display control unit 232 determines a visible state of the magnifying glass 312. If the magnifying glass 312 is hidden (is not displayed) (YES in step S501), then in step S502, the magnifying glass control unit 232 determines whether the operation type indicated by the input information is touch-down. If the operation type is touch-down (YES in step S502), then in step S503, the magnifying glass display control unit 232 determines whether the display condition for the magnifying glass 312 is satisfied. If the display condition is satisfied (YES in step S503), the processing proceeds to magnifying glass display processing (step S504). The magnifying glass display processing is described below.

If, in step S502, the operation type is not touch-down (NO in step S502), or if, in step S503, the display condition is not satisfied (NO in step S503), the processing ends.

If, in step S501, the magnifying glass 312 is in the process of being displayed (NO in step S501), then in step S505, the magnifying glass display control unit 232 acquires input information from the magnifying glass input information storage unit 241 and determines whether the operation type is move. If the operation type is move (YES in step S505), the magnifying glass display control unit 232 continues the magnifying glass display processing (step S504). Thus, the operation type “move” indicates that the magnifying glass 312 being displayed is moving.

If, in step S505, the operation type is not move (NO in step S505), then in step S506, the magnifying glass display control unit 232 acquires input information from the magnifying glass input information storage unit 241 and determines whether the operation type is touch-up. If the operation type is touch-up (YES in step S506), then in step S507, the magnifying glass display control unit 232 determines whether the hiding condition for the magnifying glass 312 is satisfied. If the hiding condition is not satisfied (NO in step S507), the processing ends. If the hiding condition is satisfied (YES in step S507), the processing proceeds to magnifying glass hiding processing (step S508). The magnifying glass hiding processing is described below.

If, in step S506, the operation type is not touch-up (NO in step S506), then in step S509, the magnifying glass display control unit 232 acquires input information from the magnifying glass input information storage unit 241 and determines whether the operation type is touch-down. If the operation type is touch-down (YES in step S509), then step S510, the magnifying glass display control unit 232 performs real touch-down notification processing. Then, the processing proceeds to step S507. The real touch-down notification processing is processing for notifying an AP handling the display region 311, serving as a magnification target, of the touch-down operation performed on the magnifying glass 312. The real touch-down notification processing is described below.

If, in step S509, the operation type is not touch-down (NO in step S509), then in step S511, the magnifying glass display control unit 232 determines whether the operation type is power-saving shift. If the operation type is power-saving shift (YES in step S511), the processing proceeds to step S507. Otherwise (NO in step S511), the processing ends.

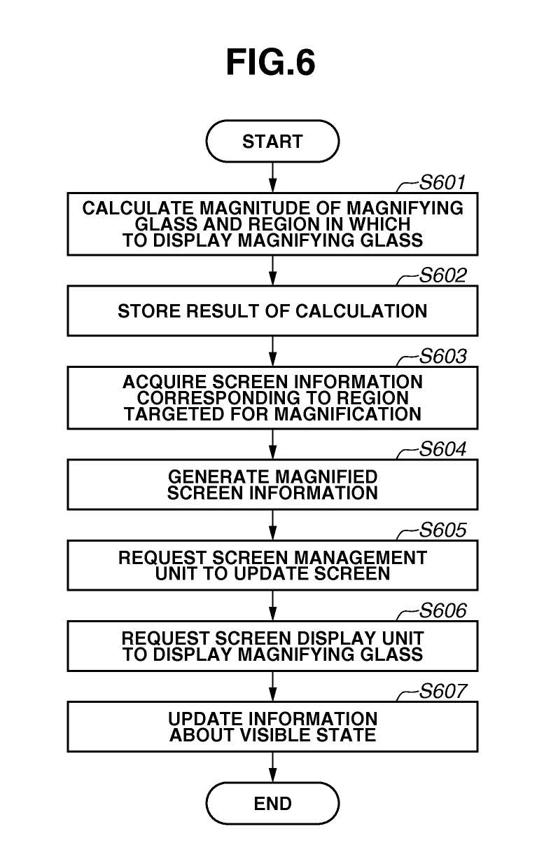

FIG. 6 is a flowchart illustrating a procedure of processing for displaying a magnifying glass.

If the display condition is satisfied, then in step S601, the magnifying glass display control unit 232 calculates the magnitude of the magnifying glass and a region in which to display the magnifying glass. In step S602, the magnifying glass display control unit 232 stores a result of the calculation into the magnification glass display information storage unit 242.

Then, in step S603, the magnifying glass display control unit 232 acquires screen information corresponding to the display region 311 having the horizontal width swidth and the vertical width sheight from the coordinates (sx, sy) of the display screen on the foreground AP managed by the screen management unit 213. Then, in step S604, the magnifying glass display control unit 232 generates magnified screen information obtained by magnifying the acquired screen information at the magnification ratio “r” acquired from the magnifying glass display information storage unit 242. Further in step S604, the magnifying glass display control unit 232 transfers the magnified screen information to the magnifying glass 312.

In step S605, the magnifying glass display control unit 232 requests the screen management unit 213 to update a screen in such a way as to display the magnifying glass 312. In step S606, the screen management unit 213 requests the screen display unit 212 to display the magnifying glass 312 on an AP lying at the foreground.

In step S607, the magnifying glass display control unit 232 determines that the magnifying glass 312 is in the process of being displayed, and updates information about the visible state stored in the magnifying glass display information storage unit 242.

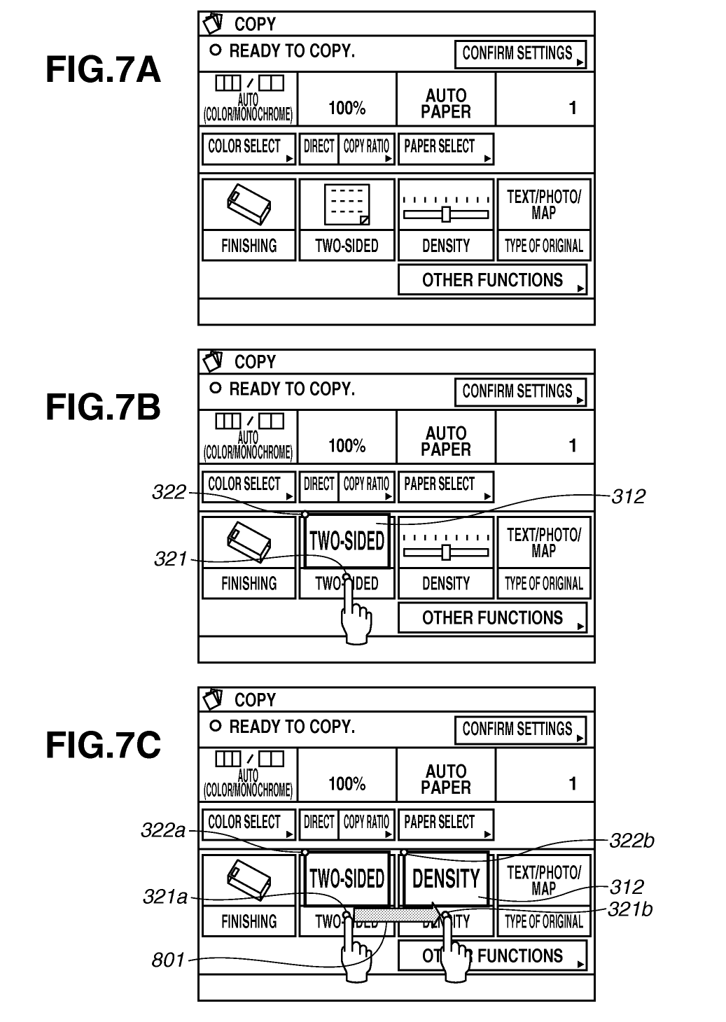

Next, an actual display example of the magnifying glass 312 is described with reference to FIGS. 7A, 7B, and 7C. FIG. 7A illustrates an example in which a display screen provided by an AP that is running on the information processing apparatus 101 is displayed on the display 119. FIG. 7B illustrates an example in which, in the state illustrated in FIG. 7A, a button image region containing letters “TWO-SIDED” is detected as an operation position (coordinates of an input point) 321, and a magnifying glass 312 with the coordinates 322 set as the starting point is displayed. FIG. 7C illustrates an example in which an operation position 321a is changed to an operation position 321b by move 801 in the state illustrated in FIG. 7B, and, accordingly, the coordinates 322a of the starting point of the magnifying glass 312 is changed to the coordinates 322b. In the example illustrated in FIG. 7C, a button image region containing letters “DENSITY” is magnified instead of the button image region containing letters “TWO-SIDED”.

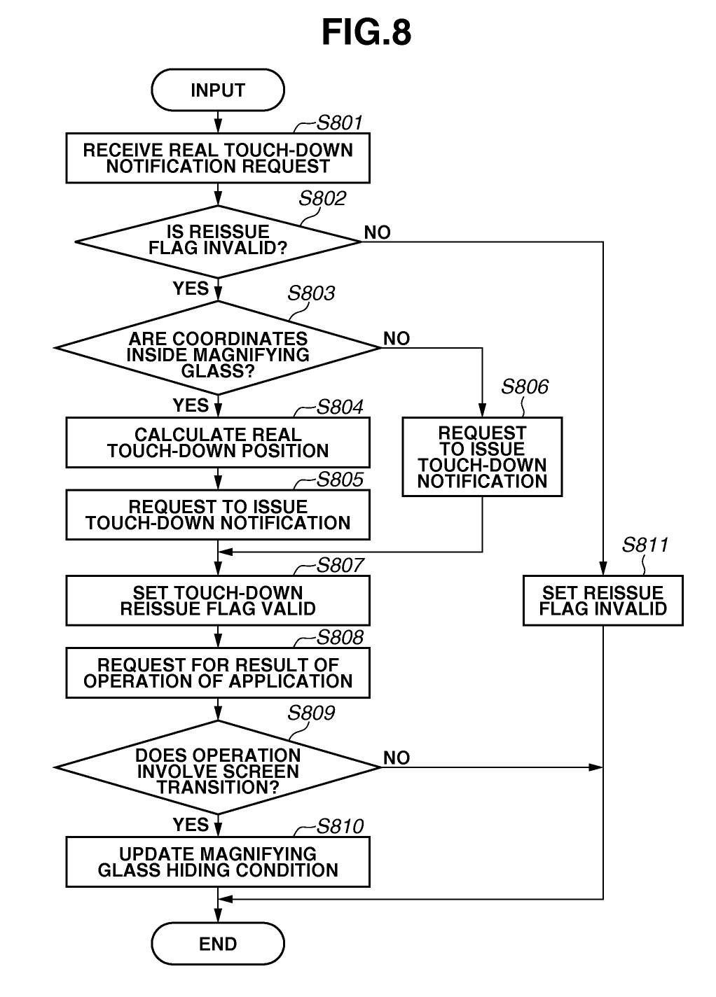

FIG. 8 is a flowchart illustrating a procedure of processing for real touch-down notification.

In step S801, the magnifying glass notification reissue control unit 250 receives a real touch-down notification request from the magnifying glass display control unit 232. In step S802, the magnifying glass notification reissue control unit 250 determines whether a reissue flag for touch-down is invalid. As described above, if the input information is not associated with the reissue flag, the magnifying glass notification reissue control unit 250 sets the reissue flag invalid. If the reissue flag is invalid (YES in step S802), then in step S803, the magnifying glass notification reissue control unit 250 determines whether the touch-down operation position 401 is inside the magnifying glass 312. If the touch-down operation position 401 is inside the magnifying glass 312 (YES in step S803), then in step S804, the magnifying glass notification reissue control unit 250 calculates a real touch-down position 402.

Then, in step S805, the magnifying glass notification reissue control unit 250 requests the input information control unit 210 to issue a touch-down notification to an AP that manages a position corresponding the calculated real touch-down position 402. If, in step S803, the touch-down operation position 401 is not inside the magnifying glass 312 (NO in step S803), then in step S806, the magnifying glass notification reissue control unit 250 requests the input information control unit 210 to issue a touch-down notification to the above-mentioned AP while keeping the touch-down operation position 401.

In step S807, after making the above-described request, the magnifying glass notification reissue control unit 250 sets the reissue flag valid. In other words, the magnifying glass notification reissue control unit 250 associates the reissue flag with the input information. Then, in step S808, the magnifying glass notification reissue control unit 250 requests the screen management unit 213 for a result of operation of the AP performed in response to the reissued touch-down notification.

In step S809, the magnifying glass notification reissue control unit 250 determines whether the acquired result of operation of the AP involves screen transition. If the acquired result of operation of the AP does not involve screen transition (NO in step S809), the processing ends. If the acquired result of operation of the AP involves screen transition (YES in step S809), then in step S810, the magnifying glass notification reissue control unit 250 updates the magnifying glass hiding condition in such way as to set a condition involving screen transition valid.

If, in step S802, the reissue flag is valid (NO in step S802), then in step S811, the magnifying glass notification reissue control unit 250 sets the reissue flag invalid. Then, the processing ends.

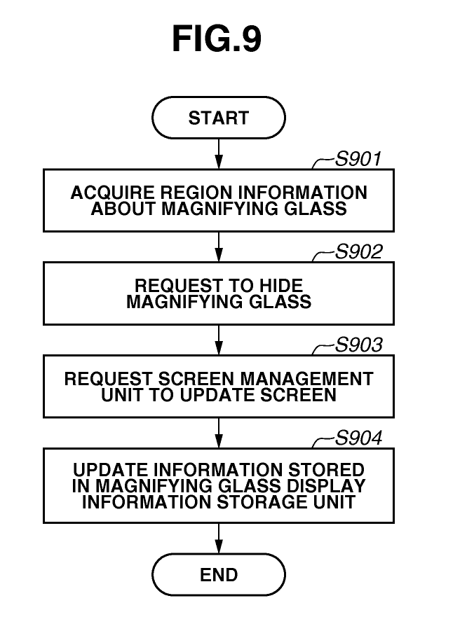

FIG. 9 is a flowchart illustrating a procedure of processing for hiding the magnifying glass. The present exemplary embodiment is configured to determine whether to hide the magnifying glass, by comparing the operation type detected by the input information control unit 210 with a previously determined hiding condition. Then, the present exemplary embodiment continues displaying the magnifying glass on the display screen until the operation type satisfying the hiding condition is detected.

Therefore, in step S901, if the detected operation position or operation type satisfies the hiding condition for the magnifying glass 312, the magnifying glass display control unit 232 acquires region information about the magnifying glass 312 from the magnifying glass display information storage unit 242. Then, in step S902, the magnifying glass display control unit 232 supplies the acquired region information to the screen management unit 213 and requests the screen management unit 213 to hide (not to display) the magnifying glass 312. In step S903, the screen management unit 213 requests the screen display unit 212 to update the screen and to re-draw the magnification region, which has been covered over by the magnifying glass 312, based on the region information.

In step S904, the magnifying glass display control unit 232 determines that the magnifying glass 312 has been hidden and updates information of the visible state stored in the magnifying glass display information storage unit 242.

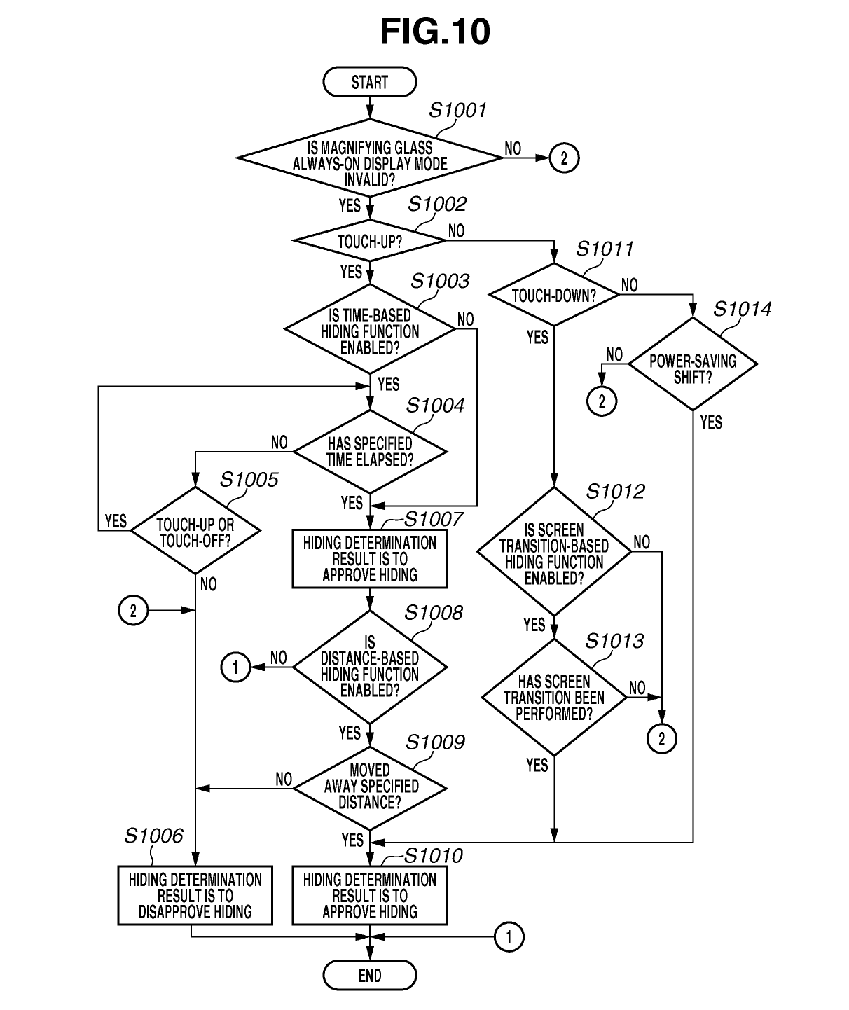

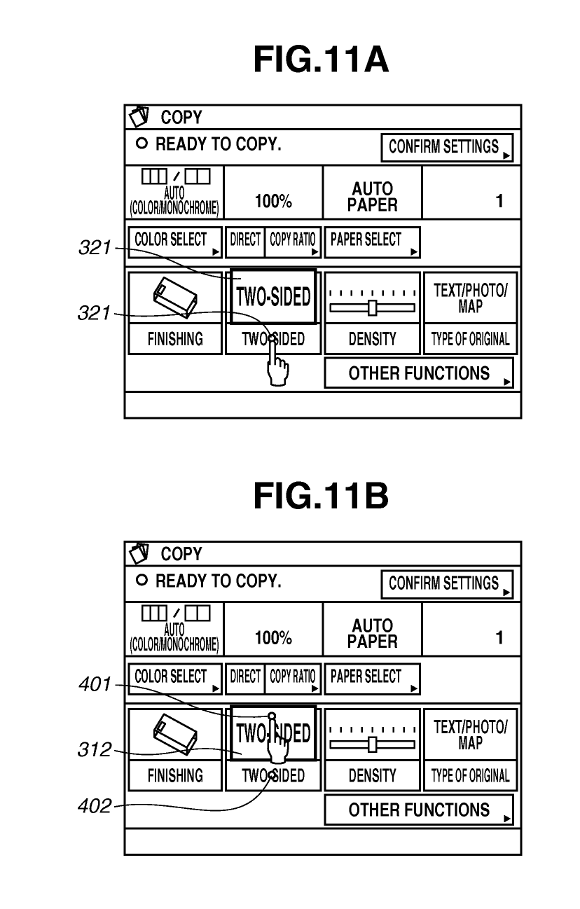

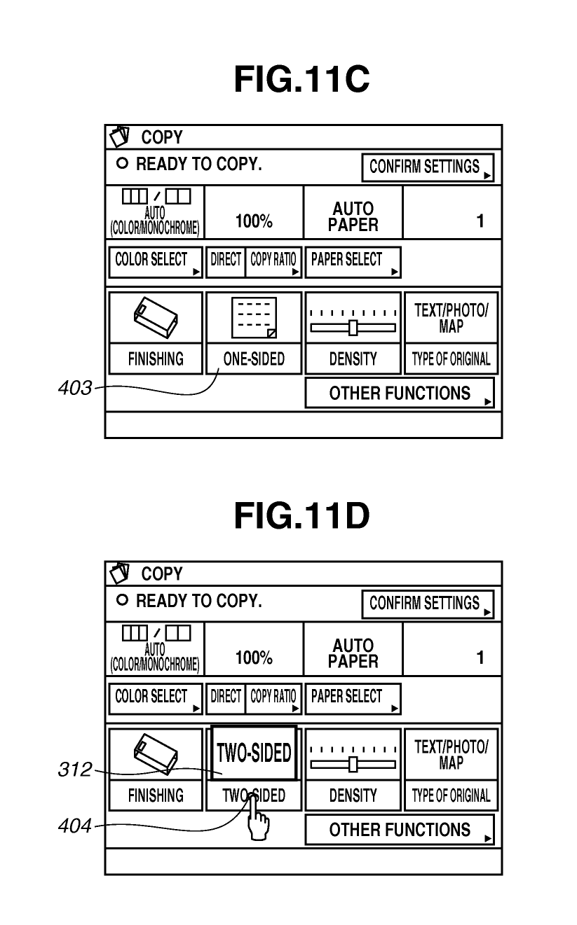

The information processing apparatus 101 according to the present exemplary embodiment allows the hiding condition for the magnifying glass 312, which is in the process of being displayed, to be set in various ways. In the following, a detailed procedure of processing for hiding the magnifying glass 312 is described with reference to FIG. 10 and FIGS. 11A, 11B, 11C, and 11D. FIG. 10 is a flowchart illustrating a detailed procedure of hiding determination processing performed based on the hiding condition.

In step S1001, the magnifying glass display control unit 232 determines whether the magnifying glass always-on display mode is disabled. If the magnifying glass always-on display mode is disabled (YES in step S1001), then in step S1002, the magnifying glass display control unit 232 acquires input information from the magnifying glass input information storage unit 241 and determines whether the detected operation type is touch-up. If the detected operation type is touch-up (YES in step S1002), then in step S1003, the magnifying glass display control unit 232 determines whether a function for hiding the magnifying glass 312 based on an elapsed time after touch-up (the time-based hiding function) is enabled. If the time-based hiding function is enabled (YES in step S1003), then in step S1004, the magnifying glass display control unit 232 determines whether a predetermined specified time has elapsed from touch-up. If the specified time has not yet elapsed (NO in step S1004), then in step S1005, the magnifying glass display control unit 232 acquires input information from the magnifying glass input information storage unit 241 and determines whether the operation type is touch-up or touch-off. If the operation type is touch-up or touch-off (YES in step S1005), the processing returns to step S1004. Otherwise (NO in step S1005), then in step S1006, the magnifying glass display control unit 232 determines that the hiding determination result is to disapprove hiding of the magnifying glass. Then, the processing ends.

If, in step S1003, it is determined that the function for hiding the magnifying glass 312 based on an elapsed time after touch-up is disabled (NO in step S1003), or if, in step S1004, the specified time has elapsed (YES in step S1004), then in step S1007, the magnifying glass display control unit 232 determines that the hiding determination result is to approve hiding of the magnifying glass.

Then, in step S1008, the magnifying glass display control unit 232 determines whether a distance-based hiding function is enabled. If the distance-based hiding function is not enabled (NO in step S1008), the processing ends. If the distance-based hiding function is enabled (YES in step S1008), then in step S1009, the magnifying glass display control unit 232 determines whether the finger or pen has moved away from the display screen by a predetermined specified distance or more. If the finger or pen has moved away from the display screen by the predetermined specified distance or more (YES in step S1009), then in step S1010, the magnifying glass display control unit 232 determines that the hiding determination result is to approve hiding of the magnifying glass. Then, the processing ends. If the finger or pen has not moved away from the display screen by the predetermined specified distance or more (NO in step S1009), the processing proceeds to step S1006, in which the magnifying glass display control unit 232 determines that the hiding determination result is to disapprove hiding of the magnifying glass. Then, the processing ends.

If, in step S1002, it is determined that the operation type is not touch-up (NO in step S1002), then in step S1011, the magnifying glass display control unit 232 determines whether the operation type is touch-down. If the operation type is touch-down (YES in step S1011), then in step S1012, the magnifying glass display control unit 232 determines whether a screen transition-based hiding function is enabled. If the screen transition-based hiding function is enabled (YES in step S1012), then in step S1013, the magnifying glass display control unit 232 determines whether screen transition has been performed. If screen transition has been performed (YES in step S1013), the processing proceeds to step S1010, in which the magnifying glass display control unit 232 determines that the hiding determination result is to approve hiding of the magnifying glass. Then, the processing ends.

If, in step S1012, the screen transition-based hiding function is not enabled (NO in step S1012), or if, in step S1013, screen transition has not been performed, the processing proceeds to step S1006, in which the magnifying glass display control unit 232 determines that the hiding determination result is to disapprove hiding of the magnifying glass. Then, the processing ends.

If, in step S1011, the operation type is not touch-down (NO in step S1011), then in step S1014, the magnifying glass display control unit 232 determines whether the operation type is power-saving shift. If the operation type is power-saving shift (YES in step S1014), the processing proceeds to step S1010, in which the magnifying glass display control unit 232 determines that the hiding determination result is to approve hiding of the magnifying glass. Then, the processing ends. If the operation type is not power-saving shift (NO in step S1014), the processing proceeds to step S1006, in which the magnifying glass display control unit 232 determines that the hiding determination result is to disapprove hiding of the magnifying glass. Then, the processing ends.

Furthermore, if, in step S1001, the magnifying glass always-on display mode is not enabled (NO in step S1001), the processing also proceeds to step S1006, in which the magnifying glass display control unit 232 determines that the hiding determination result is to disapprove hiding of the magnifying glass. Then, the processing ends.

Furthermore, the above-described processing for determining whether the hiding determination result is to approve hiding of the magnifying glass or to disapprove hiding of the magnifying glass based on the magnifying glass hiding condition is merely an example and is thus not restrictive, as long as the processing can implement control for determining the elapse of a specified time after touch-up or control for determining whether the finger or pen has moved away from the display screen by a specified distance or more. Moreover, the above-described processing is not restrictive as long as it can implement control for determining whether screen transition has been performed after touch-down. Additionally, a determination criterion for determining whether the hiding determination result is to approve or disapprove hiding of the magnifying glass based on the hiding condition for the magnifying glass is not restricted to that used in the above-described processing.

FIGS. 11A, 11B, 11C, and 11D illustrate examples of the touch-down operation on areas inside and outside the magnifying glass 312 in the state in which the screen of an AP running on the information processing apparatus 101 is displayed on the display 119. FIG. 11A illustrates an example in which the magnifying glass 312 containing the operation position (input point) 321 is displayed on the touch panel 118. In the example illustrated in FIG. 11A, a button image region containing characters “TWO-SIDED” is magnified by the magnifying glass 312.

FIG. 11B illustrates an example in which, after touch-up is performed in the state illustrated in FIG. 11A, touch-down has been performed inside the magnifying glass 312. The magnifying glass input control unit 231 receives input information indicating the touch-down operation position 401 and the execution of touch-down, and transfers the input information to the magnifying glass display control unit 232. The magnifying glass display control unit 232 requests the magnifying glass notification reissue control unit 250 to reissue a touch-down notification. The magnifying glass notification reissue control unit 250 causes the input information notification unit 211 to reissue the touch-down notification to an AP handling screen information about the real touch-down position 402.

FIG. 11C illustrates a state obtained after the input information notification unit 211 has reissued the touch-down notification. The AP, having received the touch-down notification, determines that a button image region containing characters “TWO-SIDED” has been pressed (pushed), and changes the button image region to a button image 403 containing characters “ONE-SIDED”, which is a button image that appears after pressing. Then, the magnifying glass display control unit 232 hides the magnifying glass 312 if the hiding condition for the magnifying glass 312 is satisfied.

FIG. 11D illustrates a state in which a touch-down operation has been detected on a region outside the magnifying glass 312 in the state illustrated in FIG. 11A. In this case, the magnifying glass input control unit 231 receives a touch-down notification regarding a touch-down operation position 404, and transfers the touch-down notification to the magnifying glass display control unit 232. The magnifying glass display control unit 232 requests the magnifying glass notification reissue control unit 250 to reissue a touch-down notification. In this instance, since the touch-down operation position 404 is outside the magnifying glass 312, the magnifying glass notification reissue control unit 250 requests the input information notification unit 211 to directly reissue a touch-down notification. As a result, the AP, having received the touch-down notification, causes a button image containing characters “TWO-SIDED” to be directly displayed. Therefore, a magnified display of screen information provided by the magnifying glass 312 is kept on the display screen similar to the case illustrated in FIG. 11A.

In this way, in the present exemplary embodiment, when a touch-down operation has been detected, the magnifying glass control unit 221 reissues a touch-down notification to the AP regardless of whether the touch-down operation position is inside or outside the magnifying glass 312. Then, if the touch-down notification indicates that the touch-down operation position is inside the magnifying glass 312, the AP determines that an operation has been performed on a display region appearing before being magnified corresponding to the magnifying glass 312, and thus changes the screen information. Accordingly, the user can change the screen information in the state in which the display region is magnified by the magnifying glass 312, so that the convenience of the magnifying glass 312 can be enhanced.

On the other hand, if the touch-down operation is performed on an area outside the magnifying glass 312, the display of screen information of a display region serving as a magnification source corresponding to the magnifying glass 312 is directly kept. Therefore, when an area other than the magnifying glass 312 is operated by the user, that operation is not accompanied by the movement of the user's viewpoint. Accordingly, an operational load on a user who feels the movement of viewpoint as a heavy burden, such as a person with weak sight, can be dramatically lessened.

Furthermore, in the present exemplary embodiment, hiding of a magnifying glass can be controlled based on various conditions. For example, the magnifying glass can be configured to be permanently displayed. When the magnifying glass is configured to be always displayed in a case where a user who wants to always use the magnifying glass, such a person with weak sight, is using the magnifying glass, the trouble of repeating an operation for displaying the magnifying glass can be saved.

Moreover, in the present exemplary embodiment, the magnifying glass can not only be immediately hidden after touch-up in the process of displaying the magnifying glass, but the magnifying glass can also be hidden at the time when a specified time has just elapsed or at the time when the finger or pen has moved away from the display screen by a specified distance or more. Additionally, the magnifying glass can be hidden based on a power-saving mode shift notification, which the information processing apparatus 101 issues in such a situation that the user does not operate the information processing apparatus 101 for a long time.

Accordingly, for example, in a case where the user is replaced by a user who does not need the magnifying glass, the trouble of the new user hiding the magnifying glass can be saved.

Furthermore, in the present exemplary embodiment, hiding of the magnifying glass is controlled depending on whether screen transition is performed as a result of touch-down operation in the state in which the magnifying glass is being displayed. Accordingly, the magnifying glass continues being displayed even in a case where characters in a transition-destination screen are sufficiently large, so that such a situation that visibility is impaired can be avoided.

On the other hand, in a case where screen transition is not performed, the magnifying glass can continue being displayed. Therefore, it becomes unnecessary to perform an operation for re-displaying the magnifying glass, so that operability can be dramatically improved.

In the present exemplary embodiment, an application that provides screen information is notified of an operation position and operation type on a display screen including a magnified display region. Therefore, the application can recognize operations performed on areas inside and outside the magnified display region. Accordingly, for example, such a situation that an operation on an area other than the magnified display region cannot be performed until the magnified display region is closed can be avoided.

The units described throughout the present disclosure are exemplary and/or preferable modules for implementing the processes described in the present disclosure. The modules can be hardware units (such as a field programmable gate array, a digital signal processor, an application specific integrated circuit or the like) and/or software modules (such as a computer readable program). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure, as long as the technical solutions they constitute are complete and applicable.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-078215 filed Apr. 4, 2014, which is hereby incorporated by reference herein in its entirety.

What is claimed is:

1. An information processing apparatus comprising:
a detection unit configured to detect an operation position and an operation type of an operation performed in a display screen;
a control unit configured to display a magnified display region, which is obtained by magnifying a predetermined display region containing the operation position, based on the operation position and the operation type detected by the detection unit; and
a notification unit configured to notify an application, which provides screen information to the display screen, of the operation position and the operation type detected in the display screen including the displayed magnified display region.

2. The information processing apparatus according to claim 1, wherein, when an always-on display mode is set, the control unit displays the magnified display region regardless of the detected operation position and operation type as long as the application is running on the information processing apparatus.

3. The information processing apparatus according to claim 1, wherein the notification unit converts the operation position and the operation type of an operation performed inside the magnified display region into coordinates of the display region appearing before being magnified, and notifies the application of the operation position and the operation type as representing the operation being performed on the converted coordinates with the operation type.

4. The information processing apparatus according to claim 3, wherein the notification unit notifies the application of the operation position and the operation type of an operation performed outside the magnified display region, without converting the operation position and the operation type, as representing the operation being performed on the operation position with the operation type.

5. The information processing apparatus according to claim 3, wherein, when receiving a response indicating that the application has performed processing on the screen information according to the operation type in response to being notified by the notification unit, the control unit displays, on the magnified display region, the screen information which reflects a result of the response.

6. The information processing apparatus according to claim 5, wherein the control unit determines whether to hide the magnified display region by comparing the operation type detected by the detection unit with a predetermined hiding condition, and displays the magnified display region on the display screen until the operation type satisfying the hiding condition is detected.

7. The information processing apparatus according to claim 6, wherein the control unit includes a storage unit configured to receive setting of the hiding condition and to store the hiding condition with the received setting, and
wherein the control unit compares the operation type detected by the detection unit with the hiding condition stored in the storage unit, and, when determining that the operation type satisfies the hiding condition, hides the magnified display region being displayed.

8. The information processing apparatus according to claim 7, wherein the hiding condition includes a specific operation on the display screen continuing for a predetermined time.

9. The information processing apparatus according to claim 7, wherein the hiding condition includes transition to a screen different from the display screen being performed.

10. The information processing apparatus according to claim 7, wherein the hiding condition includes an operating state of the information processing apparatus being a predetermined state.

11. A control method for an information processing apparatus including a detection unit configured to detect an operation position and an operation type of an operation performed in a display screen, the control method comprising:
displaying a magnified display region, which is obtained by magnifying a predetermined display region containing the operation position, based on the operation position and the operation type detected by the detection unit; and
notifying an application, which provides screen information to the display screen, of the operation position and the operation type detected in the display screen including the displayed magnified display region.

12. A computer-readable storage medium storing a computer program that causes a computer to function as:
a detection unit configured to detect an operation position and an operation type of an operation performed in a display screen;
a control unit configured to display a magnified display region, which is obtained by magnifying a predetermined display region containing the operation position, based on the operation position and the operation type detected by the detection unit; and
a notification unit configured to notify an application, which provides screen information to the display screen, of the operation position and the operation type detected in the display screen including the displayed magnified display region.
